(19) United States
(12) Patent Application Publication
(10) Pub. No.: US 2011/0055883 A1
(43) Pub. Date: Mar. 3, 2011

(54) METHOD FOR ACTIVE SWITCHING OF CONTENT IN AN IPTV-BASED PLAYLIST

(75) Inventor: George Foti, Dollard-des-Ormeaux (CA)

(73) Assignee: TELEFONAKTIEBOLAGET LM ERICSSON (PUBL), Stockholm (SE)

(21) Appl. No.: 12/549,668

(22) Filed: Aug. 28, 2009

(51) Int. Cl. H04N 7/173

(52) U.S. Cl. 725/110; 725/126; 725/109

(57) ABSTRACT

A system and method for switching between content streams in a playlist makes use of a bookmarking and state information saving process to allow an intermediate node in an IPTV network to offer an enhanced user experience. By bookmarking a user position in a content stream before switching to a second content stream, the method and system allow the user to resume viewing the first content stream at a later point over the same user-side channel and at the bookmarked location. This can also provide the user with improved channel switching speeds.

### TECHNICAL FIELD

This disclosure relates generally to bookmarking and switching between content streams in an Internet Protocol Television (IPTV) system.

### BACKGROUND

Internet Protocol based television (IPTV) employs a packet switched network infrastructure to deliver streaming content to a user. This content is either a general content stream (akin to a broadcast) that a user can join in progress or is a form of content on demand (such as video on demand) that is unicast to the user and whose playback is user controlled.

The user ability to pause content using either local buffering or network enabled pausing is well known in the art. However, if a user elects to pause a program and then switch content streams (to a second content on demand stream) a number of infrastructure problems are exposed. The user is often unable to return to the previously started content stream in progress, is typically required to begin the content stream at the start, and there is a noticeable time lag in switching content streams as a number of data and control channels need to be created (including control channels from the user to an upstream control node, and control channels from the control node to the content source) before the content can begin to be transmitted to the user.

In content on demand situations, it is common for a user to make use of a playlist. One example of a playlist could be a “season's pass” to a program that allows the user access to all episodes of a TV program in a particular season. Other such examples of playlists will be apparent to those skilled in the art. User switching of programs is typically increased when dealing with playlists as there is often related content that may encourage a user to switch content.

Reference is made below to known art references. Characterizations of these references are intended for summary of the existing art and should not be taken to be exhaustive descriptions of the teachings of the prior art. Reference to the published documents referred to below should be undertaken for a complete understanding of the teachings of each reference.

U.S. 2005/0050103 teaches the use of a bookmarking system where bookmarks are typically pre-defined by and are stored at the content provider. This allows a user the ability to jump to a pre-defined bookmarked position. In this reference, bookmarks are used to note positions of interest (e.g. chapter marks in a movie) to allow a user to quickly find the last position in a previously started program. This reference does not teach a mechanism that allows a user to automatically resume viewing from the current position if the content is switched out for another content stream.

Real Time Streaming Protocol RFC 2326 provides users with PAUSE and PLAY functionality that can be used as a primitive bookmarking so long as the session used to stream the content is maintained. One skilled in the art will appreciate that in conventional IPTV settings, it is not possible for a user to maintain a plurality of sessions, rending this approach infeasible.

The manner in which switching content streams is handled in IPTV is inefficient from the perspective of both user experience and consumption of network resources. As such, it would be desirable to provide an improved content switching mechanism.

### SUMMARY

It is an object of the present invention to obviate or mitigate at least one disadvantage of the prior art.

In a first aspect of the present invention, there is provided a method of managing user requested streaming data at an intermediate node in a network. The method comprises the steps of receiving, from a downstream terminal, a request for content from a user, the request received over a defined channel having a signaling sub-channel and a media signaling sub-channel, both sub-channels terminating at the downstream terminal; storing state information associated with a current data stream being received by the downstream terminal, the state information including identifying information about upstream content nodes and information about the current data stream; and requesting, from an upstream content source, that a data stream associated with the user-requested content be relayed to the downstream terminal over a channel associated with the media signaling sub-channel of the defined channel.

In an embodiment of the first aspect of the present invention the step of receiving a request can be performed by a downstream network interface, a processor performs the step of storing state information by storing state information in a state information database, and the step of requesting is performed by an upstream network interface, and optionally, the request for content is received from an Open IPTV Terminal Function (OITF). In another embodiment of the first aspect of the present invention, the method can also include pausing the current data stream prior to storing the state information wherein the request to pause the current data stream can be issued by the OITF.

In a further embodiment, the identifying information in the state information associated with the current data stream includes information associated with upstream content nodes including a Content Delivery Network Controller (CDNC) and Cluster Controller(CC), and optionally, further includes the step of bookmarking a position in the current data stream and storing the bookmarked position as information about the current data stream in the state information. In another embodiment of the first aspect of the present invention, the method can include the step of determining if there is stored state information associated with the user-requested content. Optionally, the step of requesting that the data stream associated with the user-requested content be relayed, can include requesting that the data stream associated with the user-requested content be relayed to the user in accordance with stored state information associated with the user requested content, wherein the step of requesting that the data stream associated with the user-requested content be relayed optionally includes requesting that the data stream associated with the user-requested content be transmitted through an upstream channel having a session initiation protocol based control channel and a real time streaming protocol based media channel, the upstream channel being different from the defined channel terminating at the downstream node. Additional steps can optionally be included such as releasing the upstream channel associated with the current data stream and maintaining the upstream channel associated with the current data stream and storing information identifying the maintained upstream channel with the state information. The step of requesting that the data stream associated with the user-requested content be relayed can also include requesting that the upstream channel be a previously maintained upstream channel. In a further embodiment, the step of storing state information is only performed if a current data stream is being transmitted to the downstream terminal, and can further include the step of ensuring the existence of a media signaling sub-channel associated with the defined channel prior to the step of requesting the data stream. In yet another embodiment of the first aspect of the present invention, the defined channel includes both a session initiation protocol based control channel and a real time streaming protocol based media channel. In another embodiment, the state information binds a real time streaming protocol session to a session initialization protocol session.

In a second aspect of the present invention, there is provided an Internet Protocol Television Control node. The node comprises a downstream network interface, an upstream network interface and a control processor. The downstream network interface receives requests for content streams from a downstream node over a downstream channel. The upstream network interface establishes upstream channels with content sources, and issues requests for content to the content sources. The control processor stores state information associated with content streams received by the downstream node in a state information database, retrieves state information about requested content streams from the state information database, and initiates the transmission of requested content to the downstream node in accordance with conditions determined by the retrieved state information.

In an embodiment of the second aspect of the present invention the control processor is operative to initiate a transmission of requested content to the downstream node over a data channel associated with existing upstream and downstream channels based on stored state information associated with the requested content. In another embodiment, the control processor is operative to initiate a transmission of requested content to the downstream node over a new upstream channel and an existing downstream channel based on stored state information associated with the requested content.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a control flow diagram illustrating nodes in an IPTV network and the control and media sessions created;

FIG. 2 is a control flow diagram illustrating the conventional handling of a user request for playlist based content;

FIG. 3 is a flowchart illustrating a method of handling a user request to switch content streams;

FIG. 4 is a control flow diagram illustrating the handling of messages used when a user requests a change in content streams;

FIG. 5 is a control flow diagram illustrating one method of handling of messages used to provide the change to a new content streams requested in FIG. 4;

FIG. 6 is a control flow diagram illustrating one method of handling of messages used to provide the change to a previously switched out content stream requested in FIG. 4;

FIG. 7 is a control flow diagram illustrating an alternate method of handling messages used when a user requests a change in content streams;

FIG. 8 is a control flow diagram illustrating one method of handling of messages used to provide the change to the content requested in FIG. 7; and

FIG. 9 illustrates an exemplary intermediate node of the present invention.

### DETAILED DESCRIPTION

The present invention is directed to a system and method for bookmarking and switching between content streams in a packet switched network such as an IPTV based network.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

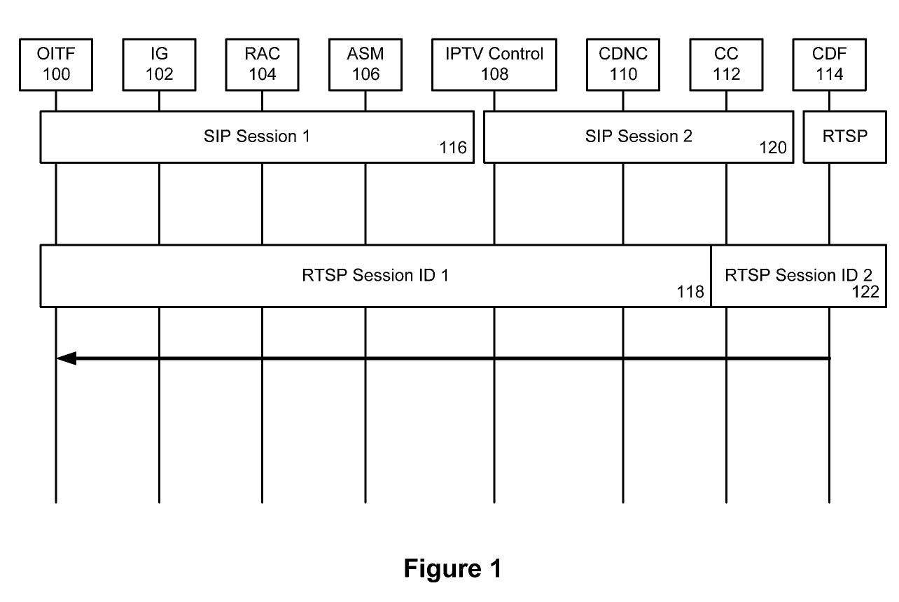

FIG. 1 illustrates both network elements and logical constructs of an IPTV packet switched infrastructure. Those skilled in the art will appreciate that these elements are known in the field and are defined in publicly available specifications related to both Internet Multimedia Systems (IMS) and IPTV. The Open IP TV Function (OITF) 100 is a terminal controlled by the user and is typically implemented as a set-top box or television appliance, though any platform capable of receiving and decoding the signal can be employed. IMS Gateway (IG) 102 is a gateway used to allow multiple networkable nodes on the user premises to access the IMS network. IMS Gateways are known in the art, and a conventional IMS gateway can be used in implementations of the system described herein without departing from the scope of the claims. Resource and Admission Controller (RAC) 104 and Authentication and Session Management Entity (ASM) 106 are also standard elements, based on Internet Multimedia Subsystem (IMS) standards known to those skilled in the art. These elements are employed to ensure system policies and terminal authentication, etc. are performed. IPTV controller 108 (also interchangeably referred to as an IPTV Control Server) is a node of particular importance because it can be relied upon to implement a number of different functions related to IPTV, or to instruct other nodes to perform various functions. The OITF 100 connects to the IPTV Controller 108 to relay user instructions, and the instructions are acted upon and verified at this node. Content Delivery Network Controller 110 (CDNC) is the interface between the service provider network and the network elements of the upstream content delivery network. The content delivery network includes cluster controller (CC) 112 and content delivery function (CDF) 114. One skilled in the art will appreciate that such a structure is known in the art, and the interaction of these individual elements is also well known. Some implementations of IPTV employ the Session Initiation Protocol (SIP) to create a control session that is used for the initialization and control of a media session invoked using the Real Time Streaming Protocol (RTSP). Other protocols can be used for the creation of each session, and those skilled in the art will appreciate that the two sessions can be treated as a single session from a logical perspective.

When OITF 100 initializes and selects a content stream, it creates SIP session 1 116 with the IPTV Controller 108. SIP Session 1 serves as a control channel. The IPTV Controller 108 then creates SIP Session 2 120 with the cluster controller 112. SIP Session 1 serves as a control channel between the OITF 100 and the IPTV Controller 108. The SIP Session 2 120 serves as the control channel for RTSP Session ID2 that governs the behavior (including setup and eventual tear down) of RTSP Session ID2 122. Note that SIP Session 2 120 allows the IPTV control server 108 to select the appropriate content delivery network using the CDNC 110 for that purpose. In that respect, the IPTV control server 108 is acting as a B2BUA (Back to Back User Agent) in this case. The Cluster Controller (CC) 112 proxies RTSP messages exchanged between the OITF 100 and the CDF 114. The CC 112 uses different RTSP identities to maintain flexibility for play list handling. As such, RTSP Session ID1 118 and RTSP Session ID2 122 are indeed a single RTSP session using different identities. The CC 112 maintains the binding between the different session identities. Those skilled in the art will appreciate that this configuration is well known. For the purposes of the following discussion, two sessions will be described, but in view of the above, it will be understood by those skilled in the art that this can either be achieved by the use of two distinct sessions or by one session with two identities.

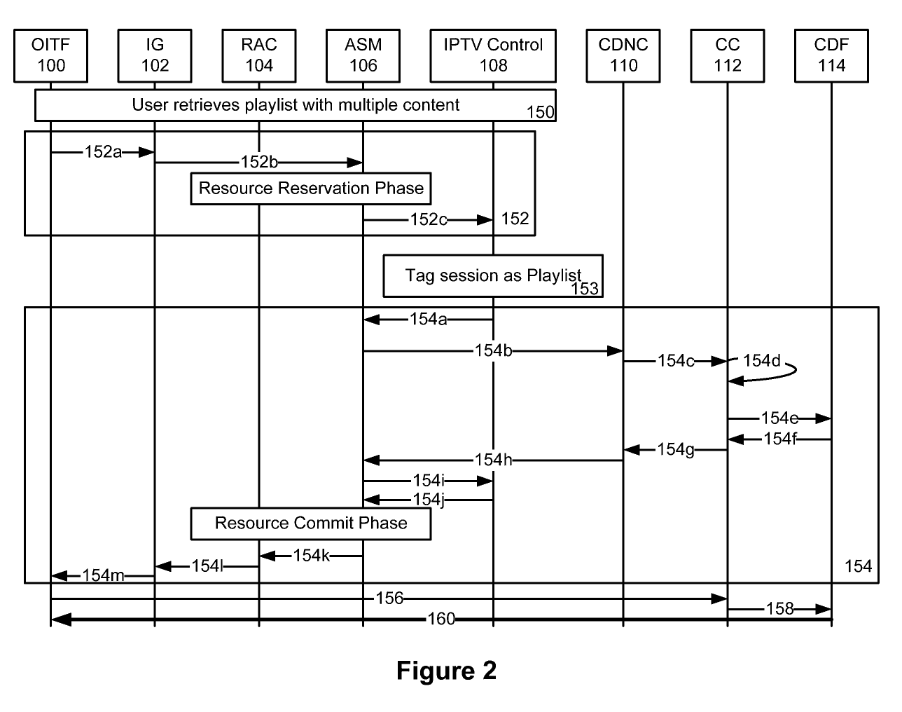

When the user selects a playlist containing multiple content streams, it is typically the IPTV Controller 108 that ensures that the resources requested by the user are available. FIG. 2 outlines a method of reserving resources and beginning the transmission of the content stream to the user. The same network entities described in FIG. 1 are shown in FIG. 2. In step 150 the user terminal 100 retrieves a playlist from the IPTV Controller 108; the playlist has a plurality of content streams. This playlist can be a complete listing of the programs available to the user, as determined by the IPTV Controller 108 based on the location of the user, the account settings of the user and the content available from any of a plurality of content sources, alternatively the playlist can be a set of content streams that are available to the user that have been packaged together for one of a number of different reasons such as a common theme. In step 152 the OITF 100 transmits a request for a program on the playlist to the IPTV controller 108. As illustrated, in one embodiment this request for content is made using the hyptertext transfer protocol (HTTP) and SIP based messages. In the embodiment illustrated in FIG. 2, the request for a program on a playlist is sent to the IPTV Controller 108 as an HTTP session setup request 152a between the OITF 100 and the IG 102, a SIP INVITE message 152b from the IG 102 to the ASM 106 and a SIP INVITE message 152c between the ASM 106 and the IPTV Controller 108. The SIP INVITE can contain a playlist URI in a Session Description Protocol packet. These messages, taken together form a request for a program on a playlist, includes a resource reservation phase. The IPTV controller 108, in step 153, can flag this session as a playlist based session, which is relevant when playlist based sessions are handled differently in the IPTV Controller 108.

Another series of SIP messages form step 154, where the IPTV Controller 108 establishes the RTSP session 122. In the illustrated exemplary embodiment, a SIP INVITE message 154a is sent to the ASM 106, which then forwards the SIP INVITE to the CC 112 through CDNC 110 as shown by messages 154b and 154c. In step 154d, a CDF 114 is selected and the CC 112 is informed. An RTSP setup message 154e is sent to the selected CDF 115, and a 200 OK message 154f (identifying RTSP ID2 122) is sent to the CC 112. Note that the CC 112 replaces the RTSP ID2 with an ID of its own, RTSP ID1 in this case, and maintains a mapping between both identities for the duration of the session. Following that, the 200 OK message is relayed from the CC 112 to the CDNC 110 (message 154g) and then to the ASM 106 (message 154h), back to the IPTV Controller 108 in message 154i, and back to the ASM 106 in message 154j. A resource commit phase can be carried out between the RAC 104 and the ASM 106, and then 200 OK messages are passed from the ASM 106 to the RAC 104 (message 154k) then to the IG 102 (message 154l).An HTTP response 154m (typically containing both the RTSP (RTSP ID1) and SIP session identifiers) is sent to the OITF 100. One skilled in the art will appreciate that a number of other known techniques can be employed to establish the media channels. Following that, OITF 100 issues an RTSP PLAY message 156 to the CC 112, which then replaces the RTSP Session ID1 with RTSP Session ID2 and subsequently proxies the RTSP PLAY message 158 to the relevant content source CDF 114. The CDF 114 responds by beginning the downstream transmission in step 160. One skilled in the art will appreciate that this is a standard method of initiating an IPTV unicast to OITF 100.

When the user wishes to switch the content stream that is being viewed, the conventional approach is to terminate the unicast from the CDF 114 and then repeat the process outlined in FIG. 2 for the newly requested content. Similarly, if the user then wishes to return to the initial content stream, no provisions are made for providing the user the ability to resume the interrupted unicast unless the OITF 100 is provided with advanced features that require more processing power than most conventional OITF 's posess. Additionally, tearing down the existing SIP and RTSP sessions and then re-establishing new session consumes both time and network resources, leading to a delay in between the content streams. These are disadvantageous because they impair the user's enjoyable experience and increase system overhead which is not desirable.

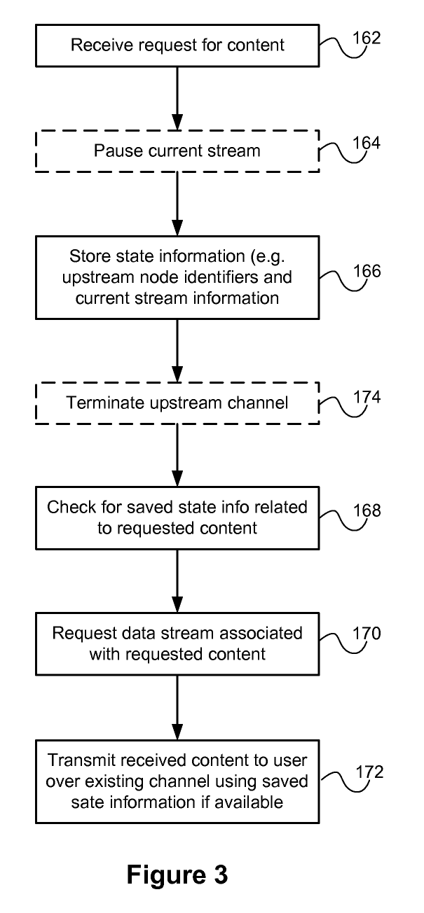

FIG. 3 is a flowchart illustrating a method of providing an enhanced content switching method that mitigates some of the problems experienced with conventional systems. In step 162, the IPTV Controller 108 receives a request from the user for switching to a new content. If an existing content stream is already being viewed, it can be paused in optional step 164. In step 166 the IPTV Controller 108 saves state information about the existing switched-out content stream. This state information can include information about the CDNC 110 and CC 112, as well as bookmarking information that records the user's present position in the switched-out content stream (currently being watched), and possibly other relevant information. The state information about the CDNC 110 and CC 112 and other such relevant information allow the IPTV Controller 108 to later re-initialize a connection with the same nodes that were streaming the content to the user. The IPTV Controller 108 has access to this information because it sits at the interface of the two SIP sessions as shown in FIG. 1, and is in the signaling path for all transactions. Upon saving relevant state information in step 166, the IPTV Controller 108 checks a database to determine if there is saved state information for the requested switched-in content in step 168. If there is no saved state information the user is viewing the switched-in content for the first time, but if there is saved state information it indicates that the user has previously viewed the switched-in content stream and switched streams part way through. The content is requested from the content source in step 170. If there is state information for the switched-in content, then the state information is preferably used to determine how the content source is contacted (e.g. which CDNC 110, CC 112 and CDF 114 are used). The IPTV Controller 108 maintains SIP Session 1 and RTSP Session ID1, which are the user connected sessions, and directs the CC 112 to transmit the content received from the CDF 114 to the downstream user over the existing channels in step 172. Furthermore, if there is existing bookmark information in state information associated with the switched-in content, the user is provided the option of resuming the content stream from the bookmarked position. By saving state information and re-using the downstream channel to the user resources and time are saved when the content stream is changed.

One issue that must be considered is what is to be done with the upstream channels that are used to send the streaming switched-out content from the CDF 114 to the CC 112 (illustrated as SIP Session 2 120 and RTSP Session ID2 122 in FIG. 1). One skilled in the art will appreciate that for the following discussion the term upstream will relate to the direction from the IPTV Controller 108 to the content source and content delivery nodes (e.g. CDNC 110, CC 112 and CDF 114), while downstream will be used to refer to sending data in the logical direction of the OITF 100. In one embodiment of the present invention, while the downstream is maintained and re-used, the upstream channel is torn down (as shown in optional step 174). In these embodiments, it may be preferable to not perform step 164 where the IPTV Controller pauses the content from the upstream source. Thus, when a new switched-in content stream is selected by the user (step 162), the IPTV controller will bookmark the user's place in the switched-out content stream and save state information about the switched-out content stream (step 166), terminate the upstream channel (step 174) check to see if there is saved state information for the new switched-in content (step 168), request the new content on behalf of the user (step 170), and then ensure that the new switched-in streaming content is provided to the user over the existing downstream channel (step 172) using the saved state information if available. One skilled in the art will appreciate that if saved state information regarding the CDNC 110 and CC 112 for a content stream is available it may be advantageous to obtain the stream from the same CDND and CC nodes, and if a bookmark is stored the user can be provided with the option of resuming playback at the bookmarked position or simply restarting the stream. This allows for re-use of the downstream channel, for any content received from the upstream channel.

In an alternate implementation, after receiving the request for new switched-in content (step 162) the streaming content is paused (step 164) and the state information is saved in step 166. The upstream channel is maintained and kept active, though the stream is paused. In step 168 the IPTV controller checks for the availability of saved state information, and the new switched-in content stream state information is requested in step 170. If state information is unavailable, a new upstream channel is created as before and switched-in content is streamed to the user over the existing downstream channel in step 172. If state information is available, it can either indicate the presence of a bookmarked position, in which case a new upstream channel is created and the user is provided the ability to resume the content stream at the bookmarked position, with the switched-in content stream being delivered to the user over the existing downstream channel, and/or it can also indicate the existence of an already active upstream channel for the switched-in content (in this case the switched-in content has been previously seen and switched-out and the network maintained the upstream channel after switching out the content as an option as opposed to tearing down the upstream channel after the content is switched-out). If an upstream channel is not torn down (bypassing step 174) then when the user switches back to a content that has a maintained upstream channel, no upstream channel needs to be established, and the streaming content can be directed to the user over the existing downstream channel in step 172. This provides a much faster content switching experience for the user, but comes at the expense of additional resources required in the network to maintain the upstream channels. Where upstream channels are maintained, one skilled in the art will appreciate that the information about those channels, including the information binding a content identifier (such as a program name or other description, or a program identification code) with the upstream channel (preferably including both the SIP based control channel and the RTSP based content channel) is preserved as state information. Additionally, in this case, if a content stream is paused and maintained, it is not strictly necessary to create a bookmark. When a user selects the content associated with a paused and active upstream channel, the upstream channel can simply be unpaused and transmitted to the user over the existing downstream channel.

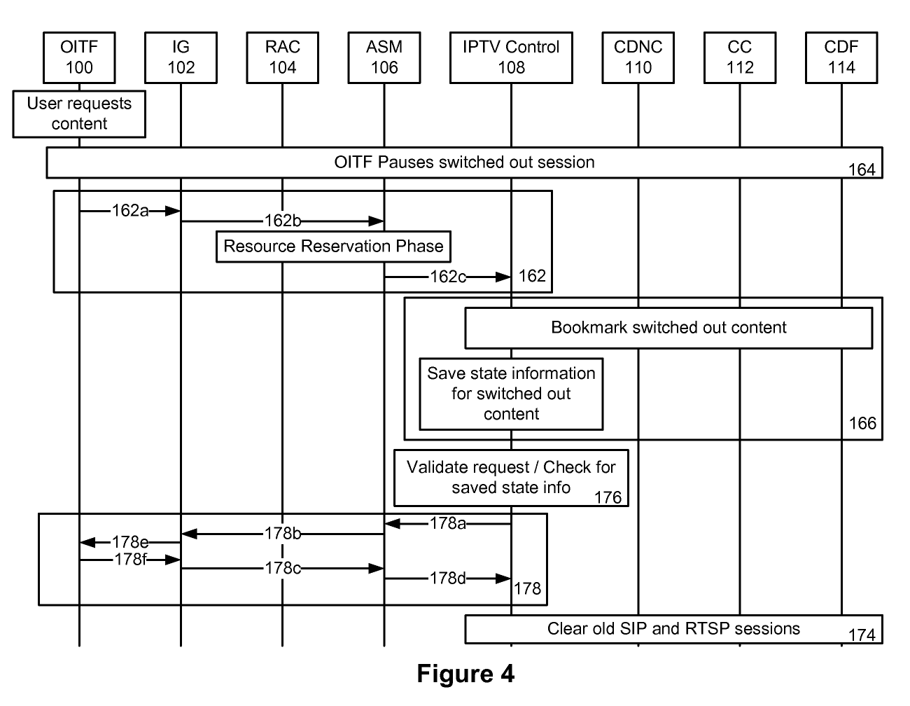

FIG. 4 is a control flow diagram, with the same network nodes illustrated in FIGS. 1 and 2, which are numbered in accordance with the description of the nodes in those figures. The messages passed in this diagram illustrate the process of a user indicating a desire to switch to a new content stream, where the upstream sessions are not preserved after switching contents. In step 164 the OITF 100 issues a request to pause the existing content stream. Those skilled in the art will appreciate that this control message is sent to the CC 112, which then relays the message to the upstream content source, CDF 114, typically using the RTSP data session. Pausing can by bypassed and is not required prior to switching to a new content stream, hence step 164 is optional, especially where bookmarking is employed as switching back to a content stream that has been bookmarked will obviate the need to pause a stream. In step 162, the user requests a new content stream. As with the method illustrated in FIG. 2, this request for content can be composed of HTTP and SIP based messages. In the illustrated embodiment, an HTTP session setup request 162a is transmitted from the OITF 100 to the IG 102. The IG 102 issues a SIP UPDATE or re-INVITE message 162b to the ASM 106, which in turn forwards a SIP re-INVITE message 162c to the IPTV Controller 108. In step 166 the IPTV Controller 108 bookmarks the present location in the switched-out content stream and then saves the bookmark and other state information for the switched-out content. As noted above, while pausing is not required where bookmarking is employed, bookmarking is not strictly required in cases when the upstream channels is paused, maintained and not torn down as switching back to that stream will allow the user to switch back to the paused location. In step 176, the IPTV controller validates the request for new switched-in content. This validation of the request for new content can also include the step of checking for saved state information as described in step 168 of FIG. 3. In step 178 the user is provided a message indicating that the content is being switched. This step is optional, but does provide feedback to the user which prevents the user from believing that the OITF 100 is frozen during the content switch. In the illustrated embodiment, a SIP MESSAGE message 178a is forwarded from the IPTV Controller 108 to the ASM 106, which forwards the SIP MESSAGE message 178b to the IG 102. At the same time an HTTP 200 OK response is sent by IG 102 to OITF 100 that includes the SIP MESSAGE message so that the message can be displayed to the viewer. The OITF sends to the IG 102 the SIP 200 OK response to the SIP MESSAGE in an HTTP Pending message 178f. The IG 108, in turn forwards the SIP 200 OK response to the ASM as 178c, and then on to the IPTV Controller 108 as 178d. In step 174 the upstream SIP and RTSP sessions for the switched out content are released.

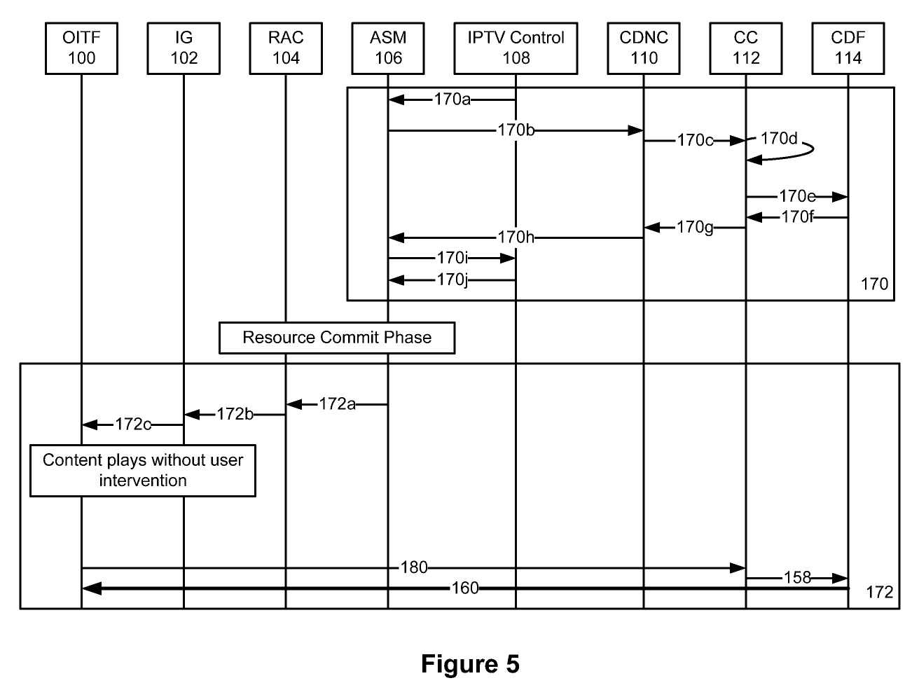

In FIG. 5, exemplary message flows for the establishment of a new upstream channel for the switched-in content are illustrated. One skilled in the art will appreciate that while FIG. 4 illustrates the messages passed to handle a user request to change away from an existing content stream, FIG. 5 illustrates the messages passed to retrieve the requested content and forward it to the user. Thus, the steps of FIG. 5 can follow the steps illustrated in FIG. 4. In step 170, SIP messages are passed between the IPTV controller 108, the ASM 106, the CDNC 110, the CC 112 and the CDF 114, to establish an upstream RTSP session between the CC 112 and the CDF 114. One skilled in the art will appreciate that the messages 170a-170j are similar to messages 154a-154j transmitted in step 154 of FIG. 2. For the sake of clarity, the same SIP and RTSP based messages have been illustrated, though one skilled in the art will appreciate that other messages or protocols could be employed. Upon the creation of the upstream RTSP session, the streaming switched-in content received over the new upstream channel is transmitted to the user over the existing downstream channel in step 172 after the OITF 100 issues a command to play the existing content, in the exemplary illustrated embodiment this is performed using an RTSP PLAY command. In one exemplary embodiment of step 172, SIP 200 OK messages are transmitted from ASM 106 to RAC 104 (message 172a), and from RAC 104 to IG 102 (message 172b). In response to receipt of the 200 OK message 172b, IG 102 can send an HTTP 200 OK response, including optional information such as the RTSP session ID) to the OITF 100 (as shown in message 172c). The OITF 100 then issues an RTSP PLAY message 180, which is forwarded as message 158 to the CDF 114 by CC 112. The CDF 114 then transmits the new switched-in content to the OITF 100 in message 160.

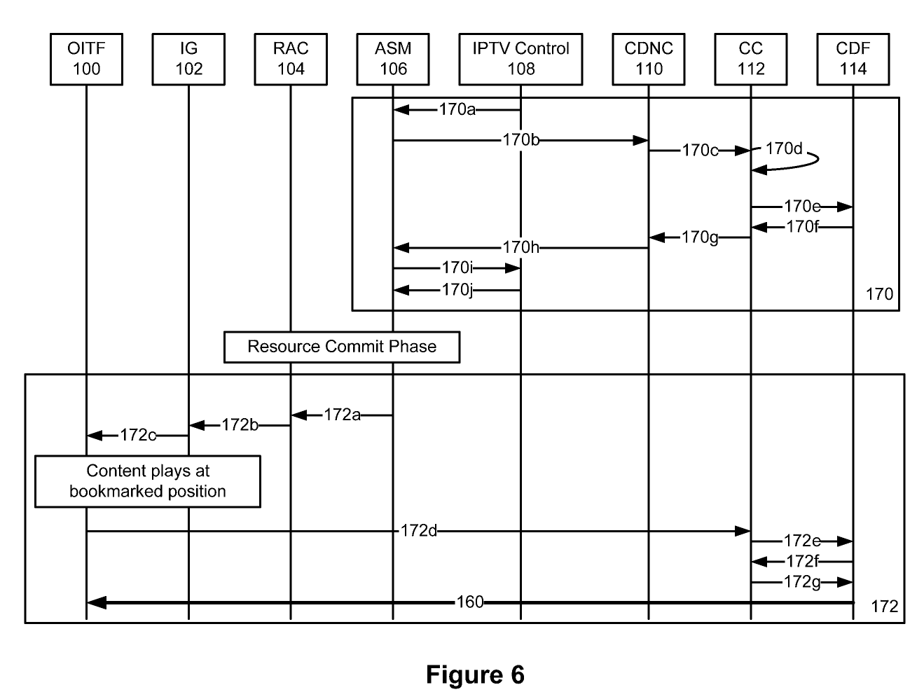

When a user indicates that the existing content is to be switched out for a previously viewed content stream for which state information exists, and where swapping out content involves terminating upstream channels, the message flows are identical to those shown in FIG. 4, save for the exception that during the validation process 176, the state information is retrieved. FIG. 6 illustrates an exemplary message passing embodiment for the resumption of a previously switched out content stream (a content stream for which state information including bookmarked information is saved). In step 170, a new SIP session is created and the previously viewed streaming content is requested. The request can be directed to a particular combination of CDNC 110 and CC 112 (where multiple CDNC and CC nodes are accessible), or can be simply initiated as in FIG. 5, where an appropriate CNDC and CC will be selected based on the switched-in content. The SIP session will create the upstream RTSP channel. One skilled in the art will appreciate that the messages 170a-170j are the same message discussed in FIG. 5 above using the same reference numerals. The payload of a particular message may differ, but the message type of this exemplary embodiment is the same. In step 172, the content is transmitted to the user over the existing downstream channel, and the user is prompted to resume from the bookmarked position (this activity can be made to be a default behavior so that user interaction is not required). As illustrated, messages 172a-172c are the same as those used in FIG. 5. However, in place of an RTSP PLAY message, such as message 180 in FIG. 5, an RTSP RESUME message 172d can be employed to allow resumption of the stream from the previously bookmarked position. The RTSP set parameters 172e can then be relayed to the CDF 114 by the CC 112, and replied to with a 200 OK message 172f. The RTSP RESUME message 172d is then forwarded to the CDF 114 by CC 112 as message 172g. The on-demand content is then resumed over message 160, much as a new program would be.

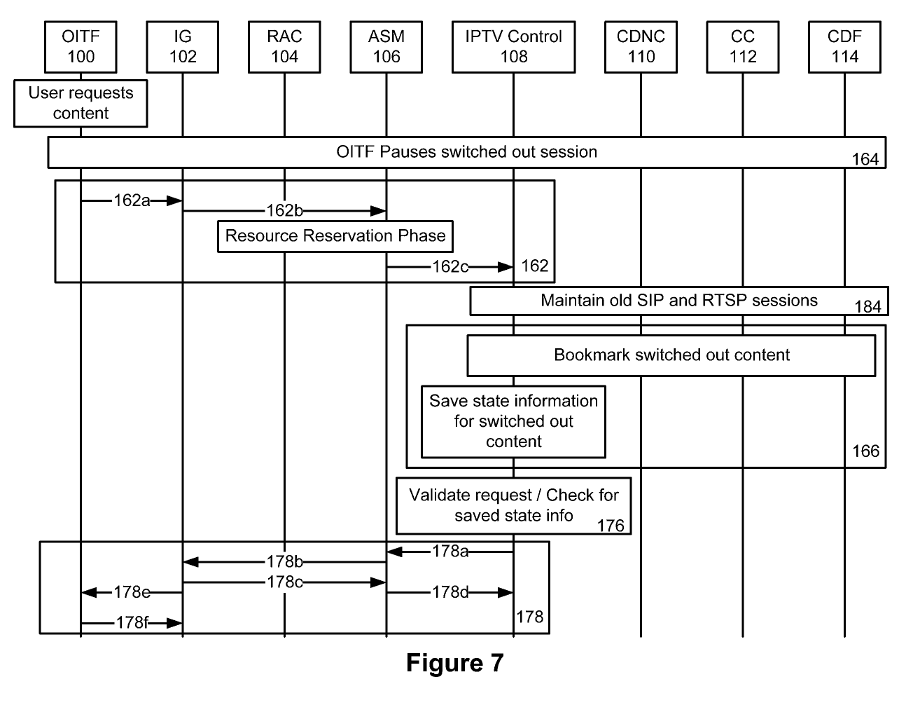

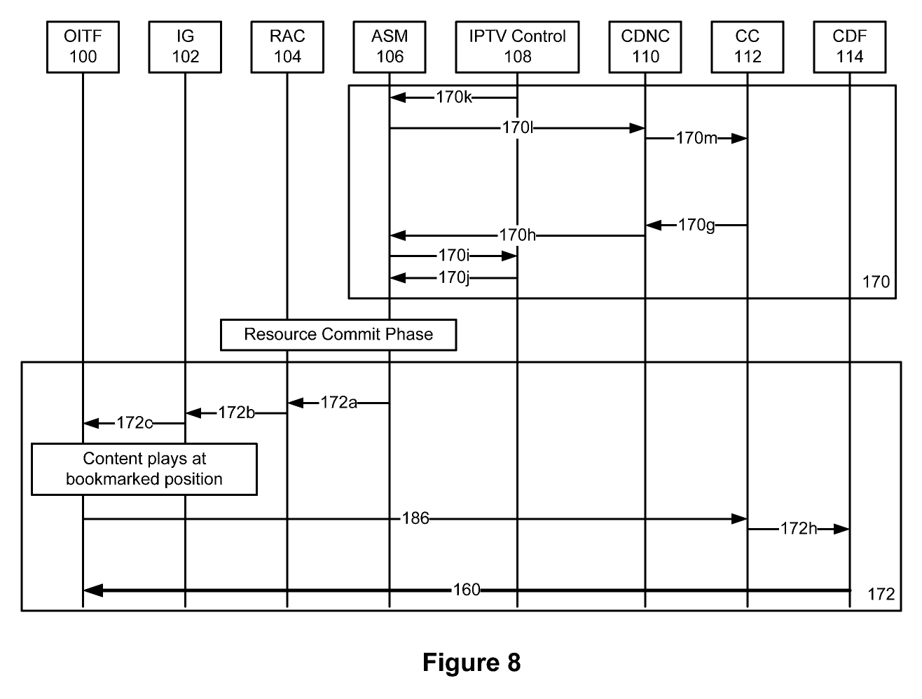

In embodiments of the method and system where previous switched out upstream channels are not terminated, different message passing diagrams occur. FIG. 7 illustrates the messages passed when the user switches out an existing content stream for another content stream. One skilled in the art will appreciate that this is similar to the method discussed in FIG. 4, and messages and steps that are a repetition of the messages and steps of FIG. 4 have been described with the same reference numerals. For the sake of clarity and conciseness though overall steps will be discussed, the implementation specific messages will not be discussed in details. A pause command, initiated at the OITF 100, but relayed through the IPTV Controller 108 is issued in step 164. In step 162 the IPTV controller 108 receives a request for the specified switched-in content stream. In step 184, the control channel between the IPTV controller 108 and the CC 112 is maintained, as is the media channel between the CC and the CDF. These channels are preferably defined by SIP sessions and RTSP sessions respectively, as previously described. One skilled in the art will appreciate that this step is clearly different from the method illustrated in FIG. 4, and stands in contrast to clearing session in formation in step 174 of FIG. 4 (which is omitted in this illustrative control flow diagram). In step 166 the IPTV Control Server 108 saves state information that includes an identification of the maintained channel for the switched out content. One skilled in the art will appreciate that by pausing the streaming switched-out content and maintaining the channel, the IPTV Controller 108 has effectively set a bookmark, though an explicit bookmark can also be saved in the state information. In step 176 the request for new content is validated. When the request is for new content (i.e. never seen and switched-out before), the validation will not find saved state information, but when the request is for previously accessed content (i.e. seen and switched-out before) the validation step will identify the saved state information associated with the requested content. In step 178 the user is provided a message indicating that the switching of content is underway.

Where no session information is identified in step 176, the process for creating a new upstream channel and transmitting the received content stream to the user illustrated in FIG. 5 is undertaken. However, where the request for content results in switching back to a previously viewed stream for which an upstream channel has been identified, the steps of requesting the switched-in content and transmitting the switched-in content to the user can be performed using the method illustrated in FIG. 8. In step 170, the user-requested switched-in content is requested from the content source. Because an existing upstream channel has been identified, a new channel does not need to be created, and instead a series of messages are passed through the upstream control channel to prepare the system for resumption of the transmission. One skilled in the art will appreciate that where the upstream control channel is a SIP based session, these messages are preferably UPDATE messages. In this specific illustrative embodiment, a SIP UPDATE message 170k is sent from the IPTV Controller 108 to the ASM 106. The ASM 106 forwards the SIP UPDATE message 170l to CDNC 110, which forwards the SIP UPDATE message 170m to the CC 112. A series of SIP 200 OK messages are sent from the CC 112 to the CDNC 110 (message 170g), from the CDNC 110 to the ASM 106 (message 170h), and from the ASM 106 to the IPTV controller 108 (message 170i.) A SIP 200 OK message 170j is then sent from the IPTV Controller 108 to the ASM 106. This message is forwarded further downstream in step 172, where the downstream channel is used to provide the OITF 100 with the information required to resume the previously paused RTSP session. As part of step 172, in the presently illustrated exemplary embodiment, messages 172a-172c are transmitted as discussed before. Message 172c includes the RTSP session information. OITF 100 issues a RTSP RESUME message 186 is response to the receipt message 172c. This message is forwarded as 172h from the CC 112 to the CDF 114 which resumes the transmission of the streaming switched-in content on the previously initialized upstream channel, the streaming switched-in content is then transmitted to the user in message 160.

Thus, two embodiments have been described that make use of the existing IPTV network infrastructure to enable a novel content switching method and system that require only modification to the functionality of a few existing nodes. The IPTV Controller 108 saves state information about the existing channel and content prior to switching to the newly requested content. When switching to newly requested content the IPTV Controller determines if existing state information is available, and if so allows the user to resume viewing at a bookmarked position. This also allows reuse of the downstream channel (both control and content sub channels) which reduces overhead and the time spent negotiating the switch of content. Furthermore, the IPTV controller 108 can optionally maintain upstream sessions, saving session identification information with the aforementioned state information allowing the resumption of a previously switched out content stream, not just from the bookmarked position, but also from the previously switched out channels. This allows a system design trade-off between memory efficiency (maintaining fewer active channels) and stream switching speeds (by eliminating the need to re-create channels that the user had previously created).

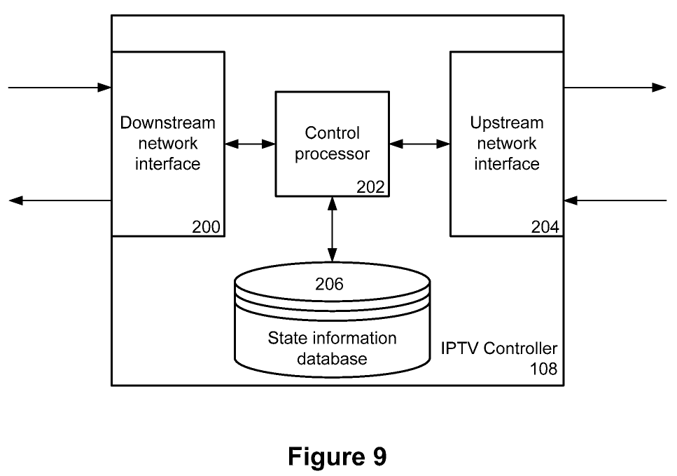

FIG. 9 is an exemplary block diagram of an IPTV Controller 108 of the present invention. IPTV Controller 108 has a downstream network interface 200, allowing it to connect to such nodes as OITF 100, and an upstream network interface 204 allowing it to connect to such nodes as CDNC 110 and CC 112. Typically these interfaces are utilized for creation of control channels, though other traffic including media and other such data can be accommodated. The interfaces are operatively connected to control processor 202. Control processor 202 examines communications received on both downstream and upstream network interfaces 200 and 204 and determines how the messages will either be handled or acted upon. Where received messages are intended for other network entities they are forwarded (e.g. downstream interface 200 receives a SIP message to initiate a new session, and in response control processor 202 issues a SIP message through the upstream interface 204), whereas other commands (e.g. a request for a new content stream) received from the downstream interface are handled using the methods outlined above. Thus, control processor 202, upon receiving a user request for new content, will save state information in state information database 206 to allow for later retrieval of the content stream. The state information can contain CDNC and CC identification along with a bookmark, and may optionally contain information related to an active upstream channel maintained by the upstream network interface 204. Control processor 202 can also issue instructions to upstream network interface 204 to create, suspend or tear down channels with upstream nodes. The network interfaces 200 and 204 can also be used to create channels between other nodes, allowing a control channel terminating at the IPTV Controller 208 to initiate, control or tear down a media channel between other connected nodes. Control processor 202, upon receipt of a request for a content stream from a downstream user will attempt to retrieve state information associated with the requested content stream from database 206. If state information associated with the content stream (and the user) is retrieved control processor 202 will control the establishment, re-establishment, or resumption of the channel from the OITF to the CDF in accordance with the retrieved state information.

Those skilled in the art will appreciate that the IPTV Controller 108 of the present invention can be implemented using general purpose or specially purposed processors and conventional network interfaces. The upstream and downstream network interfaces 200 and 204 can be integrated with each other in a single network interface, and the logically distinct functions of the interfaces can be maintained by the control processor 202 using standard computing techniques. Additionally the IPTV Controller 108 may not have an integral state information database, and may instead make use of an externally accessible database to store the required state information. This database need not be specific to the storage of state information.

One skilled in the art will appreciate that the above-described methods of determining if a requested content stream has saved state information can also be conducted during the initialization of the OITF, in which case the IPTV controller does not necessarily need to store state information as there is no current data stream to store information about. Similarly, if a content stream has been watched to completion (e.g. an episode of a television program has been completed) state information associated with that stream need not be saved, as the user has completed the viewing, and no bookmarking is required. Accordingly, state information associated with a content stream that has been fully viewed can optionally be expunged. State information for the next program in the playlist can then be searched for. By clearing state information associated with completed streams, when the user wishes to re-watch a previously completed stream it will start from the beginning as opposed to the last bookmark.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of managing user requested streaming data at an intermediate node in a network, the method comprising:
receiving, from a downstream terminal, a request for content from a user, the request received over a defined channel having a signaling sub-channel and a media signaling sub-channel, both sub-channels terminating at the downstream terminal;
storing state information associated with a current data stream being received by the downstream terminal, the state information including identifying information about upstream content nodes and information about the current data stream; and
requesting, from an upstream content source, that a data stream associated with the user-requested content be relayed to the downstream terminal over a channel associated with the media signaling sub-channel of the defined channel.

2. The method of claim 1 wherein the step of receiving a request is performed by a downstream network interface, a processor performs the step of storing state information by storing state information in a state information database, and the step of requesting is performed by an upstream network interface.

3. The method of claim 1 wherein the request for content is received from an Open IPTV Terminal Function (OITF).

4. The method of claim 1 further comprising pausing the current data stream prior to storing the state information.

5. The method of claim 4 wherein the request to pause the current data stream is issued by the OITF.

6. The method of claim 1 wherein the identifying information in the state information associated with the current data stream includes information associated with upstream content nodes including a Content Delivery Network Controller (CDNC) and Cluster Controller(CC).

7. The method of claim 1 further including the step of bookmarking a position in the current data stream and storing the bookmarked position as information about the current data stream in the state information.

8. The method of claim 1 further including the step of determining if there is stored state information associated with the user-requested content.

9. The method of claim 8 wherein the step of requesting that the data stream associated with the user-requested content be relayed, includes requesting that the data stream associated with the user-requested content be relayed to the user in accordance with stored state information associated with the user requested content.

10. The method of claim 9 wherein the step of requesting that the data stream associated with the user-requested content be relayed includes requesting that the data stream associated with the user-requested content be transmitted through an upstream channel having a session initiation protocol based control channel and a real time streaming protocol based media channel, the upstream channel being different from the defined channel terminating at the downstream node.

11. The method of claim 10 further including the step of releasing the upstream channel associated with the current data stream.

12. The method of claim 10 further including maintaining the upstream channel associated with the current data stream and storing information identifying the maintained upstream channel with the state information.

13. The method of claim 12 wherein the step of requesting that the data stream associated with the user-requested content be relayed includes requesting that the upstream channel be a previously maintained upstream channel.

14. The method of claim 8 wherein the step of storing state information is only performed if a current data stream is being transmitted to the downstream terminal.

15. The method of claim 14 further including the step of ensuring the existence of a media signaling sub-channel associated with the defined channel prior to the step of requesting the data stream.

16. The method of claim 1 wherein the defined channel includes both a session initiation protocol based control channel and a real time streaming protocol based media channel.

17. The method of claim 1 wherein the state information binds a real time streaming protocol session to a session initialization protocol session.

18. An Internet Protocol Television Control node comprising:
a downstream network interface for receiving requests for content streams from a downstream node over a downstream channel;
an upstream network interface for establishing upstream channels with content sources, and for issuing requests for content to the content sources; and
a control processor for storing state information associated with content streams received by the downstream node in a state information database, for retrieving state information about requested content streams from the state information database, and for initiating the transmission of requested content to the downstream node in accordance with conditions determined by the retrieved state information.

19. The system of claim 18 wherein the control processor is operative to initiate a transmission of requested content to the downstream node over a data channel associated with existing upstream and downstream channels based on stored state information associated with the requested content.

20. The system of claim 18 wherein the control processor is operative to initiate a transmission of requested content to the downstream node over a new upstream channel and an existing downstream channel based on stored state information associated with the requested content.
